(19) United States
(12) Patent Application Publication
(10) Pub. No.: US 2024/0090000 A1
(43) Pub. Date: Mar. 14, 2024

(54) FEEDBACK TRANSMISSIONS IN SMALLER-BANDWIDTH SLOTS

(71) Applicant: QUALCOMM Incorporated, San Diego, CA (US)

(72) Inventors: Kianoush HOSSEINI, San Diego, CA (US); Wei YANG, San Diego, CA (US); Alexandros MANOLAKOS, Escondido, CA (US)

(21) Appl. No.: 18/263,326

(22) PCT Filed: Apr. 14, 2022
(86) PCT No.: PCT/US2022/071711

§ 371 Date: Jul. 27, 2023

(30) Foreign Application Priority Data
Apr. 15, 2021 (GR) 20210100266

(51) Int. Cl. H04W 72/40; H04L 1/1812; H04W 72/0446

(52) U.S. Cl. CPC H04W 72/40; H04L 1/1812; H04W 72/0446

(57) ABSTRACT

Various aspects of the present disclosure generally relate to wireless communication. In some aspects, a first user equipment (UE) may receive, from a second UE, a physical sidelink shared channel (PSSCH) transmission in an uplink slot or in a smaller-bandwidth slot. The UE may transmit, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot. Numerous other aspects are described.

### CROSS-REFERENCE TO RELATED APPLICATION

This patent application claims priority to Greek Provisional Patent Application No. 20210100266, filed on Apr. 15, 2021, entitled “FEEDBACK TRANSMISSIONS IN SMALLER-BANDWIDTH SLOTS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for feedback transmissions in smaller-bandwidth slots.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a first user equipment (UE) includes receiving, from a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and transmitting, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a method of wireless communication performed by a first UE includes performing, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and receiving, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a first UE for wireless communication includes a memory and one or more processors, coupled to the memory, configured to: receive, from a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and transmit, to the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a first UE for wireless communication includes a memory and one or more processors, coupled to the memory, configured to: perform, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and receive, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a non-transitory computer-readable medium storing a set of instructions for wireless communication includes one or more instructions that, when executed by one or more processors of a first UE, cause the first UE to: receive, from a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and transmit, to the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a non-transitory computer-readable medium storing a set of instructions for wireless communication includes one or more instructions that, when executed by one or more processors of a first UE, cause the first UE to: perform, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and receive, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a first apparatus for wireless communication includes means for receiving, from a second apparatus, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and means for transmitting, to the second apparatus and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

In some aspects, a first apparatus for wireless communication includes means for performing, to a second apparatus, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and means for receiving, from the second apparatus and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a sub-band full-duplex (SBFD) slot, in accordance with the present disclosure.

FIG. 6 is a diagram illustrating an example of a sidelink resource pool in an uplink portion of a slot, in accordance with the present disclosure.

FIG. 7 is a diagram illustrating an example of determining a physical sidelink feedback channel (PSFCH) resource, in accordance with the present disclosure.

FIG. 8 is a diagram illustrating an example associated with feedback transmissions in smaller-bandwidth slots, in accordance with the present disclosure.

FIGS. 9-10 are diagrams illustrating example processes associated with feedback transmissions in smaller-bandwidth slots, in accordance with the present disclosure.

FIG. 11 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

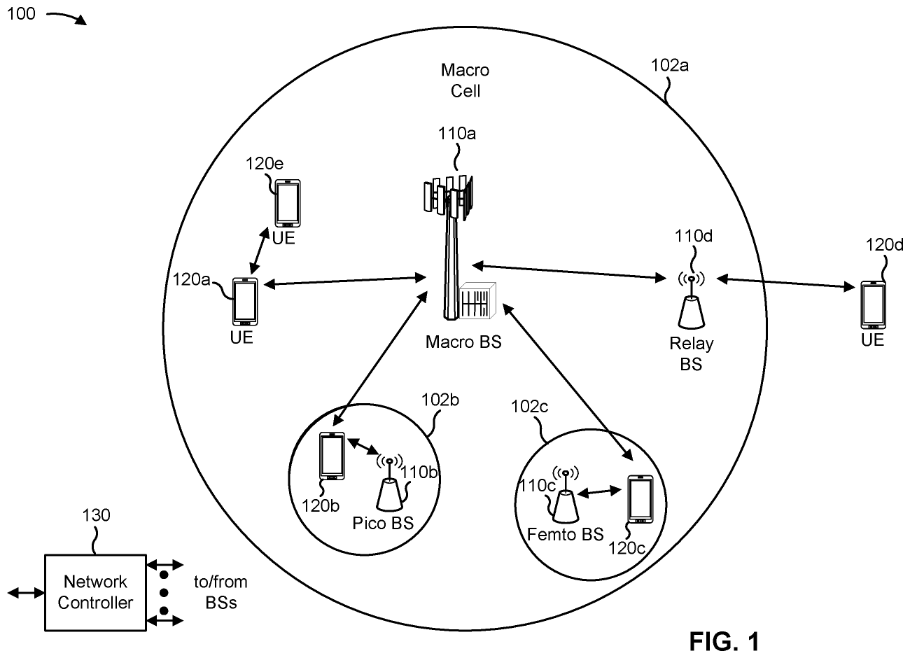

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2L) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

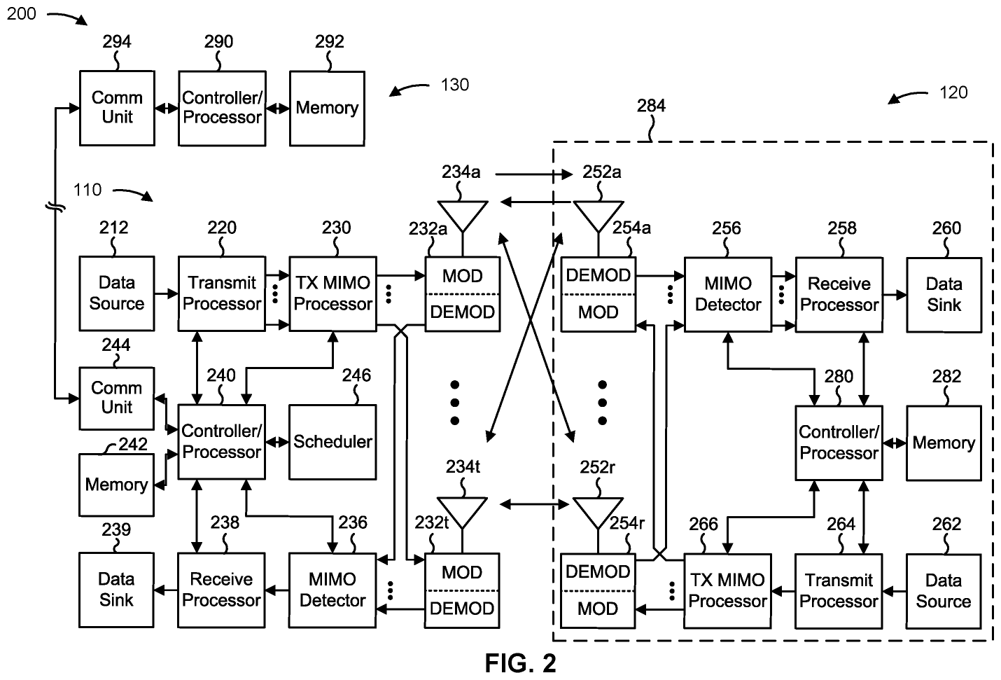

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

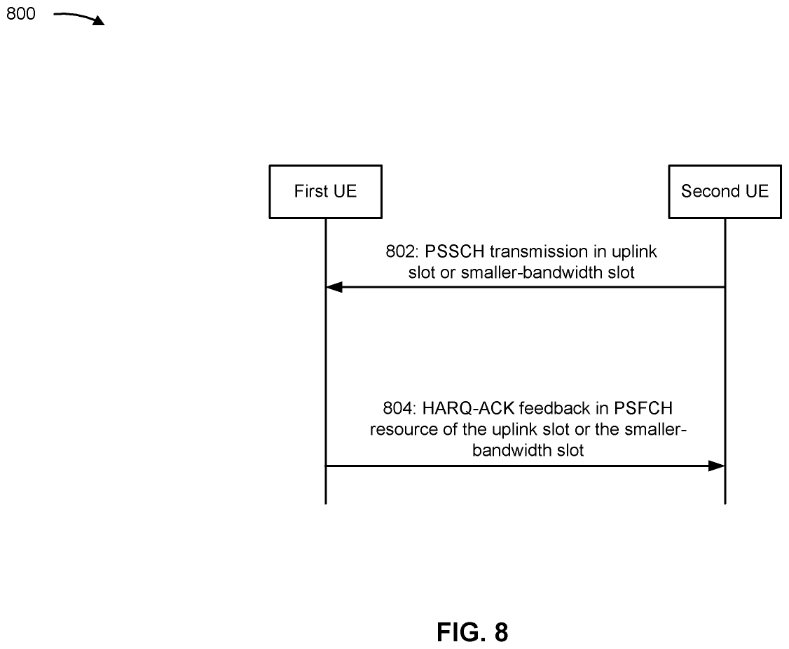

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-10).

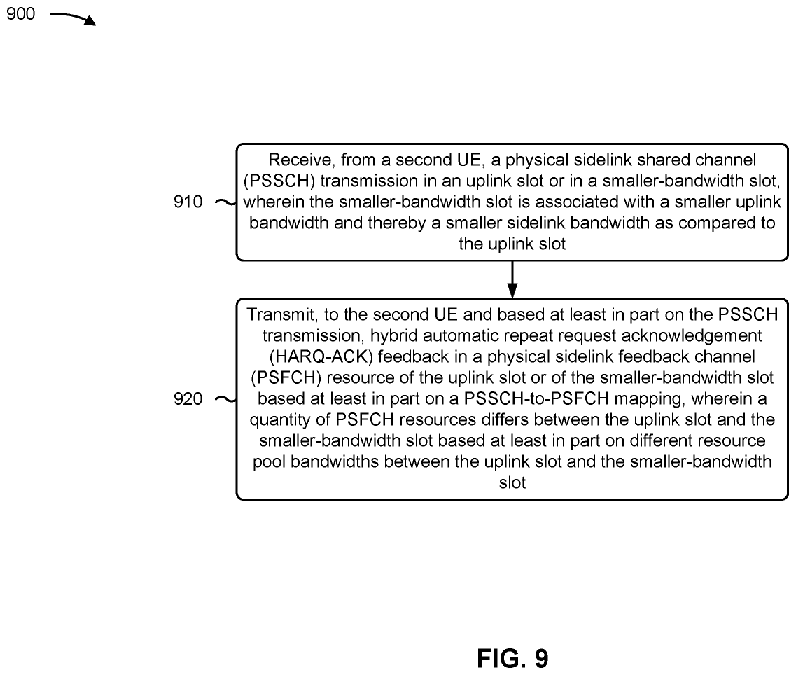

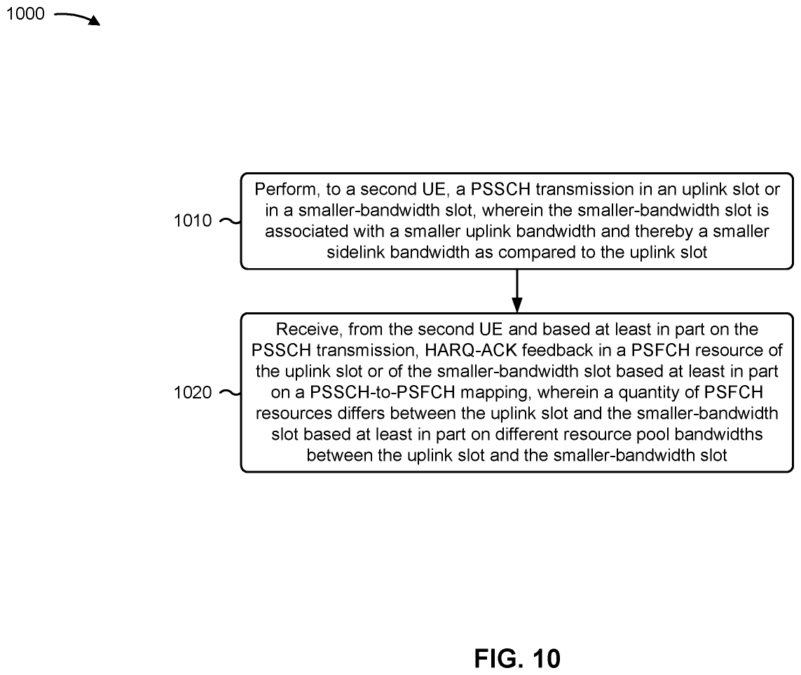

The controller/processor 240 of the base station 110, the controller/processor 280 of the UE 120, and/or any other component(s) of FIG. 2 may perform one or more techniques associated with feedback transmissions in smaller-bandwidth slots, as described in more detail elsewhere herein. For example, the controller/processor 240 of the base station 110, the controller/processor 280 of the UE 120, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving, from a second UE (e.g., UE 120e), a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and/or means for transmitting, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot. The means for the first UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, a first UE (e.g., UE 120a) includes means for performing, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot; and/or means for receiving, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot. The means for the first UE to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

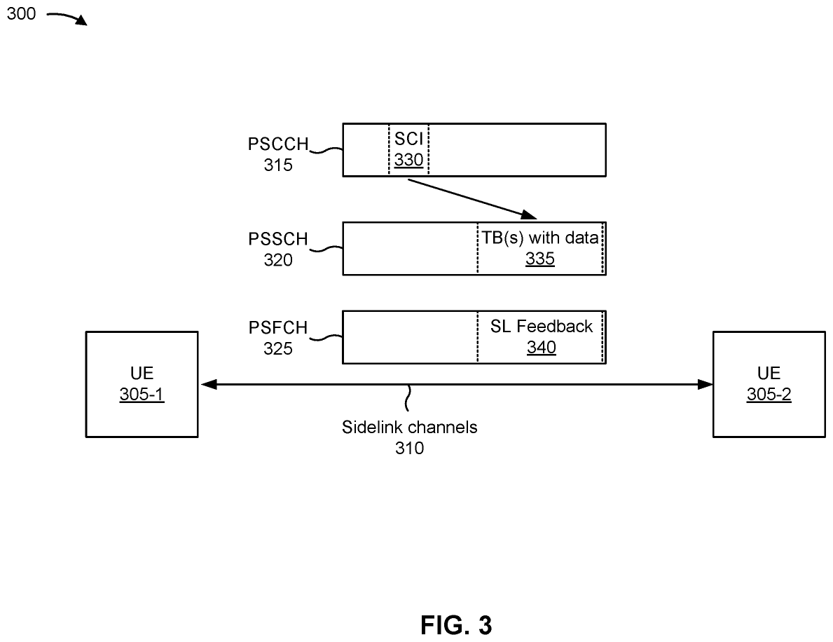

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, V2P communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to aphysical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as HARQ feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, may measure an RSRQ parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, an MCS to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

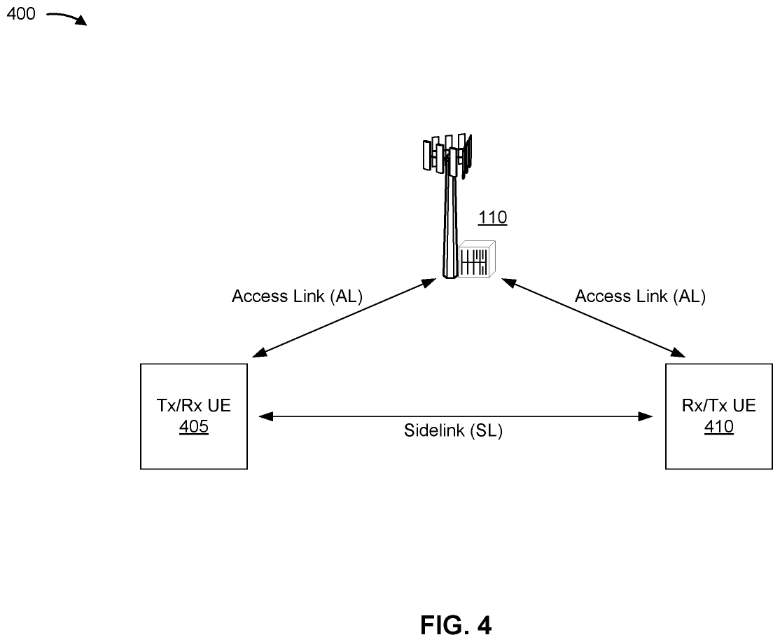

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

Full-duplex communications may allow a base station (or gNB) and a UE to transmit and receive on a same set of resources, thereby providing essentially twice as much bandwidth as half-duplex communications in which only a base station or a UE is allowed to transmit or receive on a set of resources. However, full-duplex communications may be associated with various complications, such as self-interference between a downlink transmission and an uplink transmission, gNB-to-gNB interference, UE-to-UE interference, and/or additional implementation complexity.

Sub-band full-duplex (SBFD) may realize some of the benefits of full-duplex communications, while circumventing some of the complications associated with full-duplex communications. An SBFD slot may include both downlink resources and uplink resources. The SBFD slot may include some gaps budgeted across the downlink resources and the uplink resources. In other words, downlink resources and uplink resources within the SBFD slot may be separated by gaps, which may function to reduce self-interference and improve latency and uplink coverage.

A base station may signal an indication of SBFD slots in a common radio resource control (RRC) configuration via a system information block (SIB). The base station may signal a UE-specific indication of SBFD slots. In some cases, the indication of the SBFD slots may be a dynamic indication.

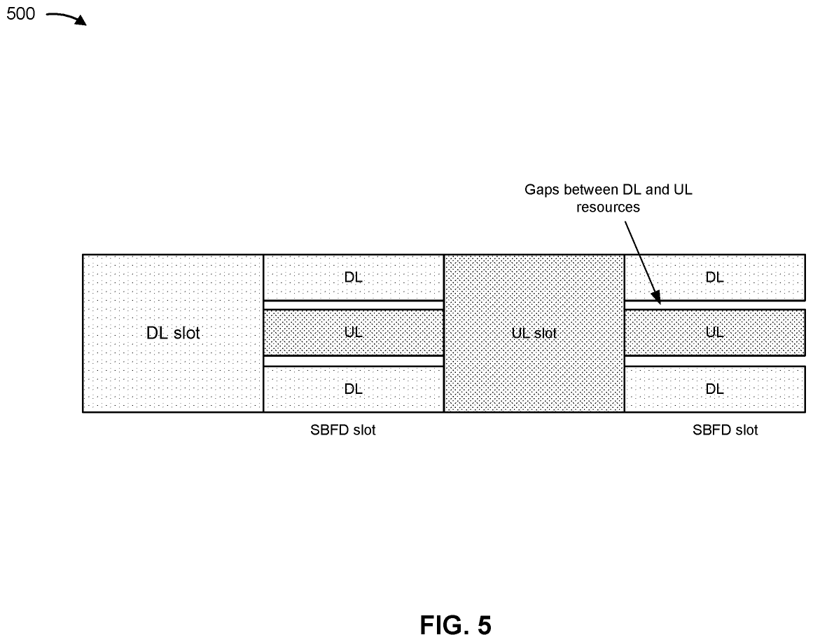

FIG. 5 is a diagram illustrating an example 500 of an SBFD slot, in accordance with the present disclosure.

As shown in FIG. 5, a slot configuration may include a combination of downlink slots, uplink slots, and/or SBFD slots. An SBFD slot may include one or more downlink resources and one or more uplink resources. A downlink resource in the SBFD slot may be separated (e.g., in time and/or frequency) from an uplink resource in the SBFD slot by a gap, which may function to reduce self-interference and improve latency and uplink coverage.

As indicated above, FIG. 5 is provided as an example. Other examples may differ from what is described with respect to FIG. 5.

Sidelink communications may be performed on uplink semi-static symbols. A UE may be (pre)configured with a set of resource pools, which may be used to perform the sidelink communications. A resource pool in the set of resource pools may be defined by a set of time-frequency resources. A minimum transmission/reception (e.g., allocation) unit in time may be a subchannel, and each subchannel may be defined as a quantity of contiguous resource blocks.

The resource pool in the set of resource pools may be (pre)configured with a resource allocation mode, such as a Mode 1 resource allocation or a Mode 2 resource allocation. In the Mode 1 resource allocation, a base station may assign resources for sidelink transmissions, and both dynamic allocations via downlink control information (DCI) format 3-x and configured transmissions (both Type-1 and Type-2) may be supported. In the Mode 2 resource allocation, a UE may perform a resource sensing, and the UE may select a resource for performing a sidelink transmission based at least in part on the resource sensing. In other words, the UE may sense resources and, based at least in part on an outcome of the sensing (e.g., priorities of different transmissions and measured power levels), the UE may select the resource for performing the sidelink transmission.

In some cases, NR and sidelink operations may be performed on a same carrier, for example, in a licensed spectrum. Further, at least a base station may support SBFD, so the base station may dynamically or semi-statically signal some slots as being SBFD slots. A bandwidth of an uplink portion in an SBFD slot may be smaller than a bandwidth associated with a regular uplink slot, since the uplink portion in the SBFD slot may coexist with a downlink portion in the SBFD slot. Since a sidelink resource pool may only be defined within an uplink portion of slots (e.g., in an uplink slot or in an uplink portion of an SBFD slot), the change in bandwidth between the uplink portion in the SBFD slot and the bandwidth associated with the regular uplink slot may impact sidelink operations.

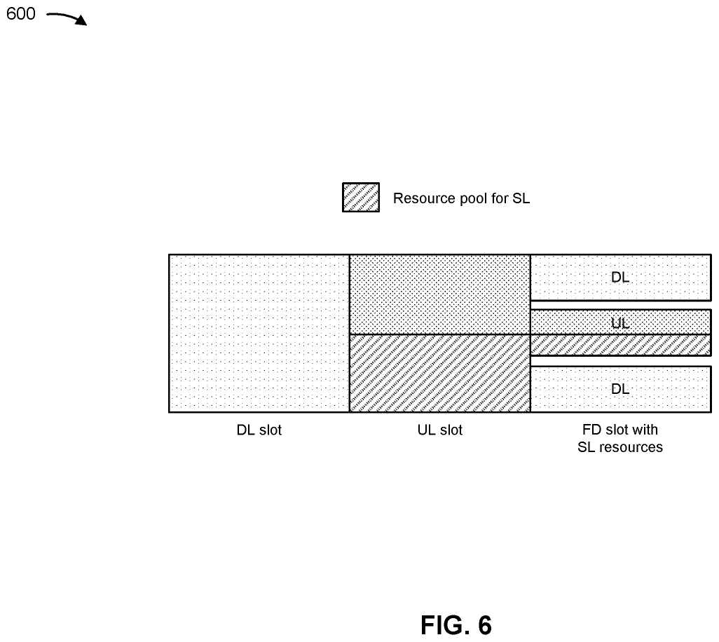

FIG. 6 is a diagram illustrating an example 600 of a sidelink resource pool in an uplink portion of a slot, in accordance with the present disclosure.

As shown in FIG. 6, a slot configuration may include a combination of downlink slots, uplink slots, and/or SBFD slots. An SBFD slot may include one or more downlink resources and one or more uplink resources. A sidelink resource pool may be defined within a portion of an uplink slot. Alternatively, or additionally, a sidelink resource pool may be defined within an uplink portion of an SBFD slot. Sidelink resource pools may not be defined within portions of downlink slots, or within downlink portions of an SBFD slot.

As indicated above, FIG. 6 is provided as an example. Other examples may differ from what is described with respect to FIG. 6.

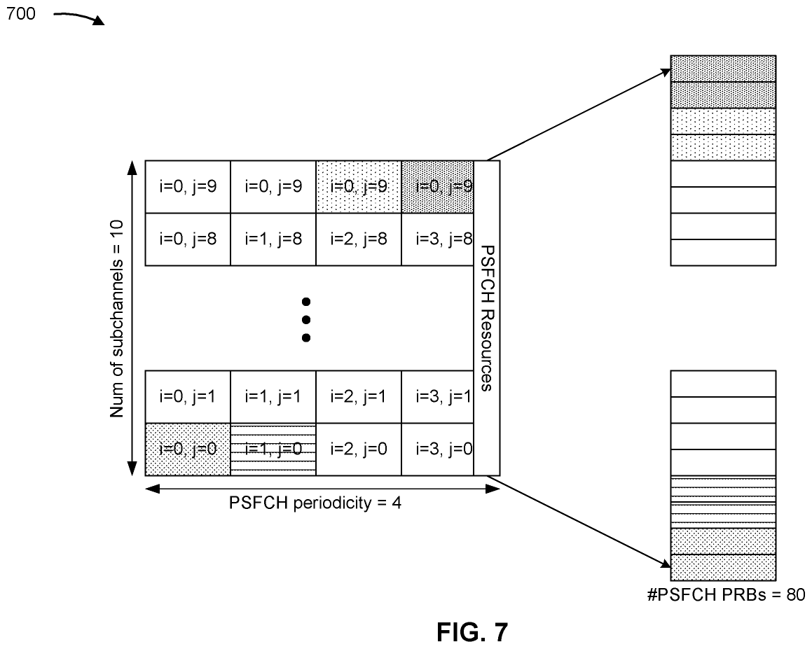

FIG. 7 is a diagram illustrating an example 700 of determining a PSFCH resource, in accordance with the present disclosure.

A period PSFCH resource (periodPSFCHresource) parameter may indicate a PSFCH periodicity, in number of slots, in a sidelink resource pool. The period PSFCH resource parameter may be set to 0, 1, 2, or 4. When the period PSFCH resource parameter is set to 0, PSFCH transmissions from a UE in the sidelink resource pool may be disabled. The UE may transmit the PSFCH in a first slot that includes PSFCH resources and is at least a number of slots, as provided by a minimum time gap of a PSFCH (MinTimeGapPSFCH) parameter, of the sidelink resource pool after a last slot of a PSSCH reception. A resource block set PSFCH (rbSetPSFCH) parameter may indicate a set of M_{PRB,set}^{PSFCH} physical resource blocks in the sidelink resource pool for PSFCH transmission. A number of subchannels (numSubchannel) parameter may indicate a number of N_{subch} sub-channels for the sidelink resource pool. A number of PSSCH slots associated with a PSFCH slot may be represented by N_{PSSCH}^{PSFCH}, and may be determined based at least in part on the periodPSFCHresource parameter. Further, M_{PRB,set}^{PSFCH}=α. N_{subch}·N_{PSSCH}^{PSFCH}, where α represents an integer value. Further,

$$\\ {M}_{subch , slot}^{PSFCH} = \frac{{M}_{PRB , set}^{PSFCH}}{{N}_{subch} \cdot {N}_{PSSCH}^{PSFCH}} ,$$

where M_{subch,slot}^{PSFCH} represents a number of PSFCH physical resource blocks (PRBs) for a sub-channel.

The UE may allocate [(i+j·N_{PSSCH}^{PSFCH})·MP_{subch,slot}^{PSFCH},(i+1+j·N_{PSSCH}^{PSFCH})·M_{subch,slot}^{PSFCH}−1] physical resource blocks from M_{PRB,set}^{PSFCH} physical resource blocks to slot i and sub-channel j, where 0≤i≤N_{PSSCH}^{PSFCH} and 0≤j≤N_{subch}.

In the example shown in FIG. 7, N_{subch} may be equal to four, which may correspond to a PSFCH periodicity. Further, N_{subch} may be equal to ten, which may correspond to a number of subchannels for the sidelink resource pool. Further, M_{subch,slot}^{PSFCH} may correspond to

$$\\ \frac{80}{4 x 10} ,$$

which is equal to two. In other words, each sub-channel may be associated with two PSFCH PRBs, which may correspond to 80 PRBs for the PSFCH. In this example, each sub-channel may be associated with two PSFCH PRBs, but the PSFCH may be sent on one of the PSFCH PRBs.

As indicated above, FIG. 7 is provided as an example. Other examples may differ from what is described with regard to FIG. 7.

A PSSCH-to-PSFCH mapping may define a fixed mapping between each sub-channel of the PSSCH and each PSFCH resource. However, one issue that arises is when the PSSCH-to-PSFCH mapping coincides with SBFD slots, or when the PSSCH-to-PSFCH mapping coincides with uplink and SBFD slots. Since SBFD slots and uplink slots are different slot types, different resource pool bandwidths for the SBFD slots versus the uplink slots may result in a quantity of sub-channels and a quantity of PSFCH resources differing between the SBFD slots and the uplink slots. The PSSCH-to-PSFCH mapping may not account for different quantities of sub-channels and PSFCH resources across different slot types, and as a result, HARQ-ACK feedback based at least in part on PSSCH transmissions may be inappropriately mapped to PSFCH resources when the PSSCH-to-PSFCH mapping is used.

In various aspects of techniques and apparatuses described herein, a first UE may receive, from a second UE, a PSSCH transmission in an uplink slot or an SBFD slot. The first UE may transmit, to the second UE and based at least in part on the PSSCH transmission, HARQ-ACK feedback in a PSFCH resource of the uplink slot or the SBFD slot based at least in part on a PSSCH-to-PSFCH mapping. A quantity of PSFCH resources may differ between the uplink slot and the SBFD slot based at least in part on different resource pool bandwidths between the uplink slot and the SBFD slot. In some aspects, the PSSCH transmission may be received in the SBFD slot and the HARQ-ACK feedback may be transmitted in the PSFCH resource of the SBFD slot based at least in part on the PSSCH-to-PSFCH mapping, and the PSSCH transmission and the HARQ-ACK feedback may not be associated with the uplink slot. In some aspects, the PSSCH transmission may be received in the uplink slot and the HARQ-ACK feedback may be transmitted in the PSFCH resource of the uplink slot based at least in part on the PSSCH-to-PSFCH mapping, and the PSSCH transmission and the HARQ-ACK feedback may not be associated with the SBFD slot. In some aspects, the PSSCH transmission may be received in the SBFD slot and the HARQ-ACK feedback may be transmitted in the PSFCH resource of the uplink slot based at least in part on the PSSCH-to-PSFCH mapping. In some aspects, the PSSCH transmission may be received in the uplink slot and the HARQ-ACK feedback may be transmitted in the PSFCH resource of the SBFD slot based at least in part on the PSSCH-to-PSFCH mapping.

FIG. 8 is a diagram illustrating an example 800 of feedback transmissions in smaller-bandwidth slots, in accordance with the present disclosure. As shown in FIG. 8, example 800 includes communication between a first UE (e.g., UE 120a) and a second UE (e.g., UE 120e). In some aspects, the first UE and the second UE may be included in a wireless network such as wireless network 100. In some aspects, the first UE and the second UE may communicate over a sidelink.

As shown by reference number 802, the first UE may receive, from the second UE, a PSSCH transmission. The first UE may receive the PSSCH transmission in an uplink slot. Alternatively, the first UE may receive the PSSCH transmission in a smaller-bandwidth slot. The smaller-bandwidth slot (e.g., an SBFD slot) may be associated with a smaller uplink bandwidth and thereby a smaller sidelink bandwidth as compared to the uplink slot. The first UE may receive the PSSCH transmission based at least in part on a sidelink resource pool associated with the uplink slot or the smaller-bandwidth slot.

As shown by reference number 804, the first UE may transmit, to the second UE and based at least in part on the PSSCH transmission, HARQ-ACK feedback in a PSFCH resource. The PSFCH resource may be in the uplink slot, or alternatively, the PSFCH resource may be in the smaller-bandwidth slot. The PSFCH resource may be in the uplink slot or the smaller-bandwidth slot based at least in part on a PSSCH-to-PSFCH mapping, which may map the PSSCH transmission to the PSFCH resource in the uplink slot or the smaller-bandwidth slot for transmitting the HARQ-ACK feedback. A quantity of PSFCH resources may differ between the uplink slot and the smaller-bandwidth slot, which may be based at least in part on different resource pool bandwidths between the uplink slot and the smaller-bandwidth slot. For example, the uplink slot may have a larger resource pool bandwidth as compared to the smaller-bandwidth slot, so the quantity of PSFCH resources associated with the uplink slot may be greater than the quantity of PSFCH resources associated with the smaller-bandwidth slot. Further, a quantity of sub-channels may differ between the uplink slot and the smaller-bandwidth slot, since the uplink slot may have the larger resource pool bandwidth as compared to the smaller-bandwidth slot.

In some aspects, the first UE may receive the PSSCH transmission in the smaller-bandwidth slot and transmit the HARQ-ACK feedback in the PSFCH resource of the smaller-bandwidth slot based at least in part on the PSSCH-to-PSFCH mapping. The PSSCH transmission and the HARQ-ACK feedback may not be associated with the uplink slot. In other words, HARQ-ACK feedback for a PSSCH transmitted in the smaller-bandwidth slot may be transmitted on the PSFCH resource in the smaller-bandwidth slot and not in a PSFCH resource in the uplink slot.

In some aspects, the first UE may receive the PSSCH transmission in the uplink slot and transmit the HARQ-ACK feedback in the PSFCH resource of the uplink slot based at least in part on the PSSCH-to-PSFCH mapping. The PSSCH transmission and the HARQ-ACK feedback may not be associated with the smaller-bandwidth slot. In other words, HARQ-ACK feedback for a PSSCH transmitted in the uplink slot may be transmitted on the PSFCH resource in the uplink slot and not in a PSFCH resource in the smaller-bandwidth slot. In some aspects, the PSSCH-to-PSFCH mapping may be applied to slots of different types separately. For example, the PSSCH-to-PSFCH mapping may be applied to uplink slots separately from smaller-bandwidth slots.

In some aspects, the first UE may receive the PSSCH transmission in the smaller-bandwidth slot and transmit the HARQ-ACK feedback in the PSFCH resource of the uplink slot based at least in part on the PSSCH-to-PSFCH mapping. In other words, for the PSSCH transmission in the smaller-bandwidth slot, the PSFCH resource in the uplink slot may be used to transmit the HARQ-ACK feedback.

In some aspects, the first UE may receive the PSSCH transmission in the uplink slot and transmit the HARQ-ACK feedback in the PSFCH resource of the smaller-bandwidth slot based at least in part on the PSSCH-to-PSFCH mapping. In other words, the PSSCH transmission in the uplink slot may be mapped to the PSFCH resource in the smaller-bandwidth slot based at least in part on the PSFCH resource being available to convey the HARQ-ACK feedback.

In some aspects, the first UE may be limited to transmitting the HARQ-ACK feedback in a same slot type as compared to receiving the PSSCH transmission. For example, when the first UE receives the PSSCH transmission in the smaller-bandwidth slot, the first UE may only transmit the HARQ-ACK feedback in the smaller-bandwidth slot. As another example, when the first UE receives the PSSCH transmission in the uplink slot, the first UE may only transmit the HARQ-ACK feedback in the uplink slot.

In some aspects, the PSSCH transmission in the uplink slot may be mapped to an available PSFCH resource in the smaller-bandwidth based at least in part on a PSFCH periodicity configuration. The PSFCH periodicity configuration may ensure that a quantity of PSFCH resource blocks in the smaller-bandwidth slot is a multiple of a quantity of sidelink sub-channels in a given PSFCH period. In some aspects, the PSSCH-to-PSFCH mapping may indicate a resource block and sub-channel mapping that is applicable to both the uplink slot and the smaller-bandwidth slot. In other words, a same PSSCH-to-PSFCH mapping that maps sub-channels to PSFCH resources, which may include a resource block and sub-channel indexing, may be used for both the uplink slots and the smaller-bandwidth slots. A resource block or sub-channel indexing for the smaller-bandwidth slots may reuse an indexing in the uplink slots.

In some aspects, the PSFCH resource in the uplink slot or the smaller-bandwidth slot may not be available, so the PSFCH resource used to transmit the HARQ-ACK feedback may be from a next PSFCH resource that is available in the uplink slot. In other words, a next available PSFCH occasion in the uplink slot may be used to transmit the HARQ-ACK feedback. In some aspects, using the next PSFCH resource in the uplink slot may impact a resource selection of the first UE. For example, another PSSCH transmission on a sub-channel may also map to the next PSFCH resource, which may cause a collision for the first UE due to multiple PSSCHs mapping to the next PSFCH resource.

In some aspects, the first UE may drop the HARQ-ACK feedback. In other words, the first UE may be unable to identify an available PSFCH resource in the smaller-bandwidth slot or the uplink slot, so the first UE may drop the HARQ-ACK feedback.

In some aspects, the first UE may map the PSSCH transmission to the PSFCH resource in the smaller-bandwidth slot based at least in part on the PSSCH-to-PSFCH mapping. The first UE may apply the PSSCH-to-PSFCH mapping based at least in part on an assumption that the PSFCH resource (or resource blocks) for the HARQ-ACK feedback are constrained within an uplink portion of the smaller-bandwidth slot. In other words, the PSFCH resource of the smaller-bandwidth slot may be associated with the uplink portion of the smaller-bandwidth slot.

In some aspects, the first UE may manage two different PSSCH-to-PSFCH mappings. The first UE may apply a first PSSCH-to-PSFCH mapping or a second PSSCH-to-PSFCH mapping depending on whether the PSSCH transmission occurs in the uplink slot or the smaller-bandwidth slot. The first PSSCH-to-PSFCH mapping may be associated with the PSSCH transmission being mapped to the smaller-bandwidth slot. The second PSSCH-to-PSFCH mapping may be associated with the PSSCH transmission being mapped to the uplink slot.

In some examples, the PSSCH transmission may trigger the HARQ-ACK feedback to be transmitted in the smaller-bandwidth slot, and the PSFCH resource in the smaller-bandwidth that corresponds to the PSSCH transmission may be available for the HARQ-ACK feedback. For example, when the HARQ-ACK feedback is triggered based at least in part on the PSSCH transmission and maps to the smaller-bandwidth slot in accordance with the PSSCH-to-PSFCH mapping, the PSFCH resource in the smaller-bandwidth that corresponds to the PSSCH transmission may be available to transmit the HARQ-ACK feedback. The PSFCH resource may be guaranteed to be available to transmit the HARQ-ACK feedback.

In some aspects, a PSSCH/PSCCH transmission that is not associated with HARQ-ACK feedback may use sub-channels that map to an unavailable PSFCH resource in the smaller-bandwidth slot. In other words, the PSSCH/PSCCH transmission that does not require HARQ-ACK feedback may still use the sub-channels that map to an unavailable PSFCH resource block in the smaller-bandwidth slot. The PSSCH/PSCCH transmission may not be associated with the HARQ-ACK feedback for broadcast, or when the HARQ-ACK feedback in SCI is disabled (e.g., when a HARQ for a transport block is not required).

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the first UE (e.g., UE 120a) performs operations associated with feedback transmissions in smaller-bandwidth slots.

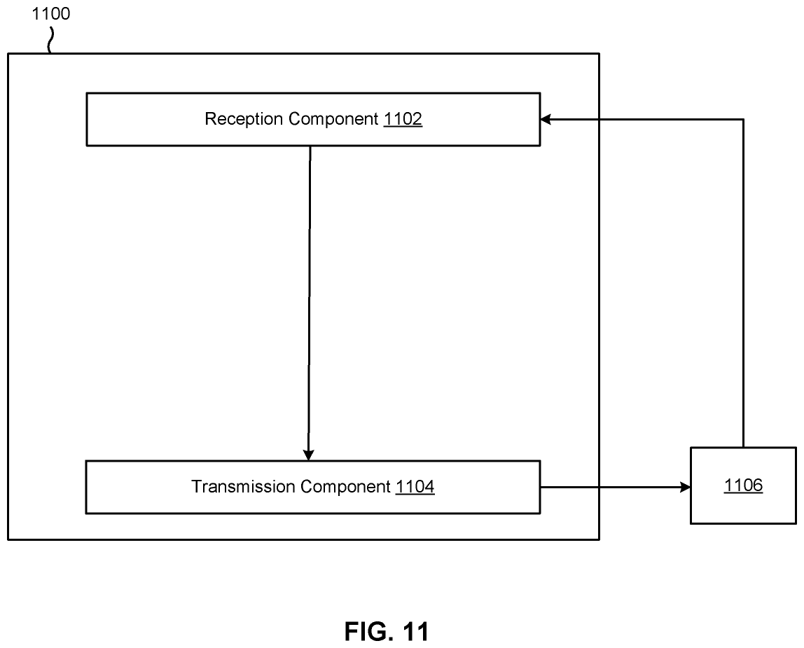

As shown in FIG. 9, in some aspects, process 900 may include receiving, from a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot (block 910). For example, the first UE (e.g., using reception component 1102, depicted in FIG. 11) may receive, from a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot, as described above.

As further shown in FIG. 9, in some aspects, process 900 may include transmitting, to the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot (block 920). For example, the first UE (e.g., using transmission component 1104, depicted in FIG. 11) may transmit, to the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot, as described above.

Process 900 may include additional aspects, such as any single aspect or any combination of aspects described below and/or in connection with one or more other processes described elsewhere herein.

In a first aspect, the PSSCH transmission is received in the smaller-bandwidth slot and the HARQ-ACK feedback is transmitted in the PSFCH resource of the smaller-bandwidth slot based at least in part on the PSSCH-to-PSFCH mapping, and the PSSCH transmission and the HARQ-ACK feedback are not associated with the uplink slot.

In a second aspect, alone or in combination with the first aspect, the PSSCH transmission is received in the uplink slot and the HARQ-ACK feedback is transmitted in the PSFCH resource of the uplink slot based at least in part on the PSSCH-to-PSFCH mapping, and the PSSCH transmission and the HARQ-ACK feedback are not associated with the smaller-bandwidth slot.

In a third aspect, alone or in combination with one or more of the first and second aspects, the PSSCH transmission is received in the smaller-bandwidth slot and the HARQ-ACK feedback is transmitted in the PSFCH resource of the uplink slot based at least in part on the PSSCH-to-PSFCH mapping, or the PSSCH transmission is received in the uplink slot and the HARQ-ACK feedback is transmitted in the PSFCH resource of the smaller-bandwidth slot based at least in part on the PSSCH-to-PSFCH mapping.

In a fourth aspect, alone or in combination with one or more of the first through third aspects, a quantity of PSFCH resource blocks in the smaller-bandwidth slot is an integer multiple of a quantity of sidelink sub-channels in a PSFCH period.

In a fifth aspect, alone or in combination with one or more of the first through fourth aspects, the PSSCH-to-PSFCH mapping indicates a resource block and sub-channel mapping and is applicable to both the uplink slot and the smaller-bandwidth slot.

In a sixth aspect, alone or in combination with one or more of the first through fifth aspects, the PSFCH resource is a next available PSFCH resource in the uplink slot when the PSSCH transmission is received in the plink slot and the HARQ-ACK feedback is not reported in the smaller-bandwidth slot.

In a seventh aspect, alone or in combination with one or more of the first through sixth aspects, the PSFCH resource of the smaller-bandwidth slot is associated with an uplink portion of the smaller-bandwidth slot.

In an eighth aspect, alone or in combination with one or more of the first through seventh aspects, the PSSCH-to-PSFCH mapping is associated with one or more of a first PSSCH-to-PSFCH mapping in which the PSSCH transmission maps to the smaller-bandwidth slot or a second PSSCH-to-PSFCH mapping in which the PSSCH transmission maps to the uplink slot.

In a ninth aspect, alone or in combination with one or more of the first through eighth aspects, the PSSCH transmission triggers the HARQ-ACK feedback to be transmitted in the smaller-bandwidth slot, and the PSFCH resource in the smaller-bandwidth that corresponds to the PSSCH transmission is available for the HARQ-ACK feedback.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first UE, in accordance with the present disclosure. Example process 1000 is an example where the first UE (e.g., UE 120a) performs operations associated with feedback transmissions in smaller-bandwidth slots.

As shown in FIG. 10, in some aspects, process 1000 may include performing, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot (block 1010). For example, the first UE (e.g., using transmission component 1104, depicted in FIG. 11) may perform, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot, as described above.

As further shown in FIG. 10, in some aspects, process 1000 may include receiving, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot (block 1020). For example, the first UE (e.g., using reception component 1102, depicted in FIG. 11) may receive, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot, as described above.

Process 1000 may include additional aspects, such as any single aspect or any combination of aspects described below and/or in connection with one or more other processes described elsewhere herein.

In a first aspect, the PSSCH transmission is performed in the smaller-bandwidth slot and the HARQ-ACK feedback is received in the PSFCH resource of the smaller-bandwidth slot based at least in part on the PSSCH-to-PSFCH mapping, and the PSSCH transmission and the HARQ-ACK feedback are not associated with the uplink slot.

In a second aspect, alone or in combination with the first aspect, the PSSCH transmission is performed in the uplink slot and the HARQ-ACK feedback is received in the PSFCH resource of the uplink slot based at least in part on the PSSCH-to-PSFCH mapping, and the PSSCH transmission and the HARQ-ACK feedback are not associated with the smaller-bandwidth slot.

In a third aspect, alone or in combination with one or more of the first and second aspects, the PSSCH transmission is performed in the smaller-bandwidth slot and the HARQ-ACK feedback is received in the PSFCH resource of the uplink slot based at least in part on the PSSCH-to-PSFCH mapping, or the PSSCH transmission is performed in the uplink slot and the HARQ-ACK feedback is received in the PSFCH resource of the smaller-bandwidth slot based at least in part on the PSSCH-to-PSFCH mapping.

In a fourth aspect, alone or in combination with one or more of the first through third aspects, a quantity of PSFCH resource blocks in the smaller-bandwidth slot is an integer multiple of a quantity of sidelink sub-channels in a PSFCH period.

In a fifth aspect, alone or in combination with one or more of the first through fourth aspects, the PSSCH-to-PSFCH mapping indicates a resource block and sub-channel mapping and is applicable to both the uplink slot and the smaller-bandwidth slot.

In a sixth aspect, alone or in combination with one or more of the first through fifth aspects, the PSFCH resource is a next available PSFCH resource in the uplink slot when the PSSCH transmission is received in the plink slot and the HARQ-ACK feedback is not reported in the smaller-bandwidth slot.

In a seventh aspect, alone or in combination with one or more of the first through sixth aspects, the PSFCH resource of the smaller-bandwidth slot is associated with an uplink portion of the smaller-bandwidth slot.

In an eighth aspect, alone or in combination with one or more of the first through seventh aspects, the PSSCH-to-PSFCH mapping is associated with one or more of a first PSSCH-to-PSFCH mapping in which the PSSCH transmission maps to the smaller-bandwidth slot, or a second PSSCH-to-PSFCH mapping in which the PSSCH transmission maps to the uplink slot.

In a ninth aspect, alone or in combination with one or more of the first through eighth aspects, the PSSCH transmission triggers the HARQ-ACK feedback to be received in the smaller-bandwidth slot, and the PSFCH resource in the smaller-bandwidth that corresponds to the PSSCH transmission is available for the HARQ-ACK feedback.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be a first UE, or a first UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the first UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a demodulator, a MIMO detector, a receive processor, a controller/processor, a memory, or a combination thereof, of the first UE described above in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the first UE described above in connection with FIG. 2. In some aspects, the transmission component 1104 may be co-located with the reception component 1102 in a transceiver.

The reception component 1102 may receive, from a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot. The transmission component 1104 may transmit, to the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

The transmission component 1104 may perform, to a second UE, a PSSCH transmission in an uplink slot or in a smaller-bandwidth slot, wherein the smaller-bandwidth slot is associated with a smaller uplink bandwidth and thereby a smaller sidelink bandwidth as compared to the uplink slot. The reception component 1102 may receive, from the second UE and based at least in part on the PSSCH transmission, HARQ-ACK feedback in a PSFCH resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a first user equipment (UE), comprising: receiving, from a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and transmitting, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

Aspect 2: The method of Aspect 1, wherein the PSSCH transmission is received in the smaller-bandwidth slot and the HARQ-ACK feedback is transmitted in the PSFCH resource of the smaller-bandwidth slot based at least in part on the PSSCH-to-PSFCH mapping, and wherein the PSSCH transmission and the HARQ-ACK feedback are not associated with the uplink slot.

Aspect 3: The method of any of Aspects 1 through 2, wherein the PSSCH transmission is received in the uplink slot and the HARQ-ACK feedback is transmitted in the PSFCH resource of the uplink slot based at least in part on the PSSCH-to-PSFCH mapping, and wherein the PSSCH transmission and the HARQ-ACK feedback are not associated with the smaller-bandwidth slot.

Aspect 4: The method of any of Aspects 1 through 3, wherein: the PSSCH transmission is received in the smaller-bandwidth slot and the HARQ-ACK feedback is transmitted in the PSFCH resource of the uplink slot based at least in part on the PSSCH-to-PSFCH mapping; or the PSSCH transmission is received in the uplink slot and the HARQ-ACK feedback is transmitted in the PSFCH resource of the smaller-bandwidth slot based at least in part on the PSSCH-to-PSFCH mapping.

Aspect 5: The method of any of Aspects 1 through 4, wherein a quantity of PSFCH resource blocks in the smaller-bandwidth slot is an integer multiple of a quantity of sidelink sub-channels in a PSFCH period.

Aspect 6: The method of any of Aspects 1 through 5, wherein the PSSCH-to-PSFCH mapping indicates a resource block and sub-channel mapping and is applicable to both the uplink slot and the smaller-bandwidth slot.

Aspect 7: The method of any of Aspects 1 through 6, wherein the PSFCH resource is a next available PSFCH resource in the uplink slot when the PSSCH transmission is received in the plink slot and the HARQ-ACK feedback is not reported in the smaller-bandwidth slot.

Aspect 8: The method of any of Aspects 1 through 7, wherein the PSFCH resource of the smaller-bandwidth slot is associated with an uplink portion of the smaller-bandwidth slot.

Aspect 9: The method of any of Aspects 1 through 8, wherein the PSSCH-to-PSFCH mapping is associated with one or more of: a first PSSCH-to-PSFCH mapping in which the PSSCH transmission maps to the smaller-bandwidth slot or a second PSSCH-to-PSFCH mapping in which the PSSCH transmission maps to the uplink slot.

Aspect 10: The method of any of Aspects 1 through 9, wherein the PSSCH transmission triggers the HARQ-ACK feedback to be transmitted in the smaller-bandwidth slot, and the PSFCH resource in the smaller-bandwidth that corresponds to the PSSCH transmission is available for the HARQ-ACK feedback.

Aspect 11: A method of wireless communication performed by a first user equipment (UE), comprising: performing, to a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and receiving, from the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

Aspect 12: The method of Aspect 11, wherein the PSSCH transmission is performed in the smaller-bandwidth slot and the HARQ-ACK feedback is received in the PSFCH resource of the smaller-bandwidth slot based at least in part on the PSSCH-to-PSFCH mapping, and wherein the PSSCH transmission and the HARQ-ACK feedback are not associated with the uplink slot.

Aspect 13: The method of any of Aspects 11 through 12, wherein the PSSCH transmission is performed in the uplink slot and the HARQ-ACK feedback is received in the PSFCH resource of the uplink slot based at least in part on the PSSCH-to-PSFCH mapping, and wherein the PSSCH transmission and the HARQ-ACK feedback are not associated with the smaller-bandwidth slot.

Aspect 14: The method of any of Aspects 11 through 13, wherein: the PSSCH transmission is performed in the smaller-bandwidth slot and the HARQ-ACK feedback is received in the PSFCH resource of the uplink slot based at least in part on the PSSCH-to-PSFCH mapping; or the PSSCH transmission is performed in the uplink slot and the HARQ-ACK feedback is received in the PSFCH resource of the smaller-bandwidth slot based at least in part on the PSSCH-to-PSFCH mapping.

Aspect 15: The method of any of Aspects 11 through 14, wherein a quantity of PSFCH resource blocks in the smaller-bandwidth slot is an integer multiple of a quantity of sidelink sub-channels in a PSFCH period.

Aspect 16: The method of any of Aspects 11 through 15, wherein the PSSCH-to-PSFCH mapping indicates a resource block and sub-channel mapping and is applicable to both the uplink slot and the smaller-bandwidth slot.

Aspect 17: The method of any of Aspects 11 through 16, wherein the PSFCH resource is a next available PSFCH resource in the uplink slot when the PSSCH transmission is received in the plink slot and the HARQ-ACK feedback is not reported in the smaller-bandwidth slot.

Aspect 18: The method of any of Aspects 11 through 17, wherein the PSFCH resource of the smaller-bandwidth slot is associated with an uplink portion of the smaller-bandwidth slot.

Aspect 19: The method of any of Aspects 11 through 18, wherein the PSSCH-to-PSFCH mapping is associated with one or more of a first PSSCH-to-PSFCH mapping in which the PSSCH transmission maps to the smaller-bandwidth slot, or a second PSSCH-to-PSFCH mapping in which the PSSCH transmission maps to the uplink slot.

Aspect 20: The method of any of Aspects 11 through 19, wherein the PSSCH transmission triggers the HARQ-ACK feedback to be received in the smaller-bandwidth slot, and the PSFCH resource in the smaller-bandwidth that corresponds to the PSSCH transmission is available for the HARQ-ACK feedback.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the memory and the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the memory and the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a first user equipment (UE) for wireless communication, comprising:
a memory; and
one or more processors, coupled to the memory, configured to:
receive, from a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and
transmit, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

2. The apparatus of claim 1, wherein the one or more processors are configured to receive the PSSCH transmission in the smaller-bandwidth slot and transmit the HARQ-ACK feedback in the PSFCH resource of the smaller-bandwidth slot based at least in part on the PSSCH-to-PSFCH mapping, and wherein the PSSCH transmission and the HARQ-ACK feedback are not associated with the uplink slot.

3. The apparatus of claim 1, wherein the one or more processors are configured to receive the PSSCH transmission in the uplink slot and transmit the HARQ-ACK feedback in the PSFCH resource of the uplink slot based at least in part on the PSSCH-to-PSFCH mapping, and wherein the PSSCH transmission and the HARQ-ACK feedback are not associated with the smaller-bandwidth slot.

4. The apparatus of claim 1, wherein the one or more processors are configured to:
receive the PSSCH transmission in the smaller-bandwidth slot and transmit the HARQ-ACK feedback in the PSFCH resource of the uplink slot based at least in part on the PSSCH-to-PSFCH mapping; or
receive the PSSCH transmission in the uplink slot and transmit the HARQ-ACK feedback in the PSFCH resource of the smaller-bandwidth slot based at least in part on the PSSCH-to-PSFCH mapping.

5. The apparatus of claim 1, wherein a quantity of PSFCH resource blocks in the smaller-bandwidth slot is an integer multiple of a quantity of sidelink sub-channels in a PSFCH period.

6. The apparatus of claim 1, wherein the PSSCH-to-PSFCH mapping indicates a resource block and sub-channel mapping and is applicable to both the uplink slot and the smaller-bandwidth slot.

7. The apparatus of claim 1, wherein the PSFCH resource is a next available PSFCH resource in the uplink slot when the PSSCH transmission is received in the uplink slot and the HARQ-ACK feedback is not reported in the smaller-bandwidth slot.

8. The apparatus of claim 1, wherein the PSFCH resource of the smaller-bandwidth slot is associated with an uplink portion of the smaller-bandwidth slot.

9. The apparatus of claim 1, wherein the PSSCH-to-PSFCH mapping is associated with one or more of: a first PSSCH-to-PSFCH mapping in which the PSSCH transmission maps to the smaller-bandwidth slot or a second PSSCH-to-PSFCH mapping in which the PSSCH transmission maps to the uplink slot.

10. The apparatus of claim 1, wherein the PSSCH transmission triggers the HARQ-ACK feedback to be transmitted in the smaller-bandwidth slot, and the PSFCH resource in the smaller-bandwidth that corresponds to the PSSCH transmission is available for the HARQ-ACK feedback.

11. An apparatus of a first user equipment (UE) for wireless communication, comprising:
a memory; and
one or more processors, coupled to the memory, configured to:
perform, to a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and
receive, from the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

12. The apparatus of claim 11, wherein the one or more processors are configured to perform the PSSCH transmission in the smaller-bandwidth slot and receive the HARQ-ACK feedback in the PSFCH resource of the smaller-bandwidth slot based at least in part on the PSSCH-to-PSFCH mapping, and wherein the PSSCH transmission and the HARQ-ACK feedback are not associated with the uplink slot.

13. The apparatus of claim 11, wherein the one or more processors are configured to perform the PSSCH transmission in the uplink slot and receive the HARQ-ACK feedback in the PSFCH resource of the uplink slot based at least in part on the PSSCH-to-PSFCH mapping, and wherein the PSSCH transmission and the HARQ-ACK feedback are not associated with the smaller-bandwidth slot.

14. The apparatus of claim 11, wherein the one or more processors are configured to:
perform the PSSCH transmission in the smaller-bandwidth slot and receive the HARQ-ACK feedback in the PSFCH resource of the uplink slot based at least in part on the PSSCH-to-PSFCH mapping; or
perform the PSSCH transmission in the uplink slot and receive the HARQ-ACK feedback in the PSFCH resource of the smaller-bandwidth slot based at least in part on the PSSCH-to-PSFCH mapping.

15. The apparatus of claim 11, wherein a quantity of PSFCH resource blocks in the smaller-bandwidth slot is an integer multiple of a quantity of sidelink sub-channels in a PSFCH period.

16. The apparatus of claim 11, wherein the PSSCH-to-PSFCH mapping indicates a resource block and sub-channel mapping and is applicable to both the uplink slot and the smaller-bandwidth slot.

17. The apparatus of claim 11, wherein the PSFCH resource is a next available PSFCH resource in the uplink slot when the PSSCH transmission is received in the uplink slot and the HARQ-ACK feedback is not reported in the smaller-bandwidth slot.

18. The apparatus of claim 11, wherein the PSFCH resource of the smaller-bandwidth slot is associated with an uplink portion of the smaller-bandwidth slot.

19. The apparatus of claim 11, wherein the PSSCH-to-PSFCH mapping is associated with one or more of: a first PSSCH-to-PSFCH mapping in which the PSSCH transmission maps to the smaller-bandwidth slot, or a second PSSCH-to-PSFCH mapping in which the PSSCH transmission maps to the uplink slot.

20. The apparatus of claim 11, wherein the PSSCH transmission triggers the HARQ-ACK feedback to be received in the smaller-bandwidth slot, and the PSFCH resource in the smaller-bandwidth that corresponds to the PSSCH transmission is available for the HARQ-ACK feedback.

21. A method of wireless communication performed by a first user equipment (UE), comprising:
receiving, from a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and
transmitting, to the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

22. The method of claim 21, wherein:
the PSSCH transmission is received in the smaller-bandwidth slot and the HARQ-ACK feedback is transmitted in the PSFCH resource of the smaller-bandwidth slot based at least in part on the PSSCH-to-PSFCH mapping, and wherein the PSSCH transmission and the HARQ-ACK feedback are not associated with the uplink slot; or
the PSSCH transmission is received in the uplink slot and the HARQ-ACK feedback is transmitted in the PSFCH resource of the uplink slot based at least in part on the PSSCH-to-PSFCH mapping, and wherein the PSSCH transmission and the HARQ-ACK feedback are not associated with the smaller-bandwidth slot.

23. The method of claim 21, wherein:
the PSSCH transmission is received in the smaller-bandwidth slot and the HARQ-ACK feedback is transmitted in the PSFCH resource of the uplink slot based at least in part on the PSSCH-to-PSFCH mapping; or
the PSSCH transmission is received in the uplink slot and the HARQ-ACK feedback is transmitted in the PSFCH resource of the smaller-bandwidth slot based at least in part on the PSSCH-to-PSFCH mapping.

24. The method of claim 21, wherein:
the PSSCH-to-PSFCH mapping indicates a resource block and sub-channel mapping and is applicable to both the uplink slot and the smaller-bandwidth slot; or
the PSSCH-to-PSFCH mapping is associated with one or more of a first PSSCH-to-PSFCH mapping in which the PSSCH transmission maps to the smaller-bandwidth slot or a second PSSCH-to-PSFCH mapping in which the PSSCH transmission maps to the uplink slot.

25. The method of claim 21, wherein:
the PSFCH resource is a next available PSFCH resource in the uplink slot when the PSSCH transmission is received in the uplink slot and the HARQ-ACK feedback is not reported in the smaller-bandwidth slot;
the PSFCH resource of the smaller-bandwidth slot is associated with an uplink portion of the smaller-bandwidth slot; or
the PSSCH transmission triggers the HARQ-ACK feedback to be transmitted in the smaller-bandwidth slot, and the PSFCH resource in the smaller-bandwidth that corresponds to the PSSCH transmission is available for the HARQ-ACK feedback.

26. A method of wireless communication performed by a first user equipment (UE), comprising:
performing, to a second UE, a physical sidelink shared channel (PSSCH) transmission in an uplink slot or in a smaller-bandwidth slot, wherein the smaller-bandwidth slot is associated with a smaller uplink bandwidth and thereby a smaller sidelink bandwidth as compared to the uplink slot; and
receiving, from the second UE and based at least in part on the PSSCH transmission, hybrid automatic repeat request acknowledgement (HARQ-ACK) feedback in a physical sidelink feedback channel (PSFCH) resource of the uplink slot or of the smaller-bandwidth slot based at least in part on a PSSCH-to-PSFCH mapping, wherein a quantity of PSFCH resources differs between the uplink slot and the smaller-bandwidth slot based at least in part on different resource pool bandwidths between the uplink slot and the smaller-bandwidth slot.

27. The method of claim 26, wherein:
the PSSCH transmission is performed in the smaller-bandwidth slot and the HARQ-ACK feedback is received in the PSFCH resource of the smaller-bandwidth slot based at least in part on the PSSCH-to-PSFCH mapping, and wherein the PSSCH transmission and the HARQ-ACK feedback are not associated with the uplink slot; or
the PSSCH transmission is performed in the uplink slot and the HARQ-ACK feedback is received in the PSFCH resource of the uplink slot based at least in part on the PSSCH-to-PSFCH mapping, and wherein the PSSCH transmission and the HARQ-ACK feedback are not associated with the smaller-bandwidth slot.

28. The method of claim 26, wherein:
the PSSCH transmission is performed in the smaller-bandwidth slot and the HARQ-ACK feedback is received in the PSFCH resource of the uplink slot based at least in part on the PSSCH-to-PSFCH mapping; or
the PSSCH transmission is performed in the uplink slot and the HARQ-ACK feedback is received in the PSFCH resource of the smaller-bandwidth slot based at least in part on the PSSCH-to-PSFCH mapping.

29. The method of claim 26, wherein:
the PSSCH-to-PSFCH mapping indicates a resource block and sub-channel mapping and is applicable to both the uplink slot and the smaller-bandwidth slot; or
the PSSCH-to-PSFCH mapping is associated with one or more of: a first PSSCH-to-PSFCH mapping in which the PSSCH transmission maps to the smaller-bandwidth slot or a second PSSCH-to-PSFCH mapping in which the PSSCH transmission maps to the uplink slot.

30. The method of claim 26, wherein:
the PSFCH resource is a next available PSFCH resource in the uplink slot when the PSSCH transmission is received in the uplink slot and the HARQ-ACK feedback is not reported in the smaller-bandwidth slot;
the PSFCH resource of the smaller-bandwidth slot is associated with an uplink portion of the smaller-bandwidth slot; or
the PSSCH transmission triggers the HARQ-ACK feedback to be received in the smaller-bandwidth slot, and the PSFCH resource in the smaller-bandwidth that corresponds to the PSSCH transmission is available for the HARQ-ACK feedback.
